(19) United States
(12) Patent Application Publication
(10) Pub. No.: US 2002/0141153 A1
(43) Pub. Date: Oct. 3, 2002

(54) Case for mounting slidably a data storage medium in a computer housing

(75) Inventor: Chien-Tung Su, Tainan City (TW)

Correspondence Address: LADAS & PARRY, 26 West 61st Street, New York, NY, 10023-7604, US

(73) Assignee: COMPUCASE ENTERPRISE CO., LTD.

(21) Appl. No.: 09/901,346

(22) Filed: Jul. 9, 2001

(30) Foreign Application Priority Data
Mar. 27, 2001 (TW) 090204666

(51) Int. Cl. G06F 1/20

(52) U.S. Cl. 361/687

(57) ABSTRACT

A case for mounting slidably a data storage medium in a computer housing includes a metal upper casing part and a cover plate. The upper casing part has a top wall with opposite front and rear edges and opposite lateral edges that interconnect the front and rear edges. The top wall has opposite upper and lower surfaces. The upper surface of the top wall is formed with a plurality of heat dissipating fins. The upper casing part further has two lateral walls with top edges connected to the lateral edges of the top wall. The cover plate has opposite lateral portions connected removably to bottom edges of the lateral walls, and cooperates with the upper casing part to confine a receiving space for receiving the data storage medium therein such that the data storage medium is in contact with the lower surface of the top wall.

### CROSS-REFERENCE TO RELATED APPLICATION

This application claims priority of Taiwan Application No. 90204666, filed on Mar. 27, 2001.

### BACKGROUND OF THE INVENTION

1. Field of the Invention

The invention relates to a case for a data storage medium, more particularly to a case for mounting slidably a data storage medium in a computer housing.

2. Description of the Related Art

A data storage medium can be mounted fixedly or removably in a computer housing. Referring to FIG. 1, to mount a data storage medium 21, such as a hard disk, in a computer housing (not shown), amounting frame 22 must first be fixed at an appropriate location in the computer housing. The mounting frame 22 includes a parallel pair of lateral confining walls 221, and a rear wall 222 interconnecting rear ends of the confining walls 221. The rear wall 222 has a heat-dissipating fan 23 mounted thereon. The mounting frame 22 has an opening 223 at front ends of the confining walls 221.

With further reference to FIG. 2, a conventional case 1 mounts slidably the data storage medium 22 on the mounting frame 22, and is shown to comprise an upper casing part 11, a plurality of fasteners 12, a metal cover plate 13, and a handle 14 at a front side of the upper casing part 11.

The upper casing part 11 is an integrally formed unit made from plastic, and includes a top wall 111, a pair of lateral walls 112 disposed on opposite lateral edges of the top wall 111, a front end cap 113 interconnecting front edges of the lateral walls 112, and a pair of connecting ribs 114 that interconnect the lateral edges of the top wall 111 to the lateral walls 112.

The top wall 111, the lateral walls 112 and the front end cap 113 cooperate to confine a receiving space 115 adapted for receiving the data storage medium 21. The top wall 111 is formed with a plurality of elongate vent holes 116. The front end cap 113 is formed with a plurality of circular vent holes 117. The fasteners 12 extend through the lateral walls 112 to fasten the data storage medium 21 to the upper casing part 11. The cover plate 13 is mounted removably on bottom ends of the lateral walls 112. Due to the handle 14, mounting and removal of the case 1 on and from the mounting frame 22 can be facilitated.

Heat that is generated during operation of the data storage medium 21 will be dissipated via a metal casing 211 of the data storage medium 21, and subsequently expelled through the vent holes 116 and 117 of the case 1. The fan 23 on the mounting frame 22 also acts to assist in heat dissipation. Because the aforesaid case 1 relies solely on air as a heat-dissipating medium, the heat-dissipating rate is relatively slow. The case 1 is thus unsuitable for new generation data storage mediums that operate at faster speeds and that generate larger amounts of heat.

A modified case for mounting slidably a data storage medium in a computer housing has been proposed heretofore to overcome the above-stated drawback. The case comprises an integrally formed metal casing frame having a pair of lateral walls interconnected by a front wall. The top and bottom ends of the casing frame are closed by a respective cover plate. Each cover plate is formed with a plurality of vent holes. The cover plates and the casing frame cooperate to confine a receiving space for the data storage medium. When in use, because the cover plates are not designed for close contact with the data storage medium, the problem of slow heat-dissipation remains unresolved.

### SUMMARY OF THE INVENTION

Therefore, the object of the present invention is to provide a case for mounting slidably a data storage medium in a computer housing, wherein heat can be dissipated rapidly during use.

Accordingly, the case of this invention includes a metal upper casing part and a cover plate.

The upper casing part has a top wall with opposite front and rear edges and opposite lateral edges that interconnect the front and rear edges. The top wall has opposite upper and lower surfaces. The upper surface of the top wall is formed with a plurality of heat dissipating fins. The upper casing part further has a pair of lateral walls with top edges connected to the lateral edges of the top wall. The lateral walls extend downwardly and respectively from the lateral edges of the top wall, and have bottom edges opposite to the upper edges.

The cover plate has opposite lateral portions connected removably to the bottom edges of the lateral walls, and cooperates with the upper casing part to confine a receiving space adapted for receiving the data storage medium therein such that the data storage medium is in contact with the lower surface of the top wall.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view illustrating a conventional case for mounting slidably a data storage medium in a computer housing;

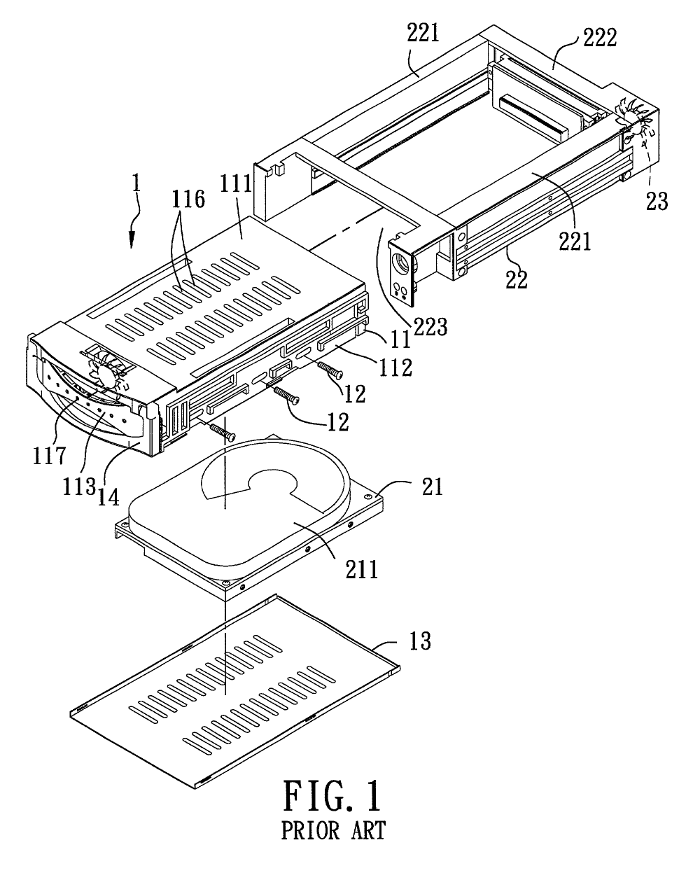

FIG. 2 is an assembled sectional view of the conventional case with the data storage medium received therein;

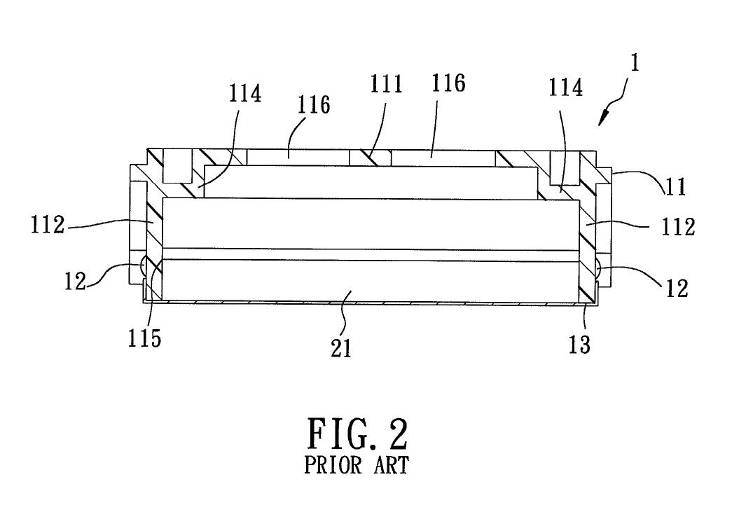

FIG. 3 is an exploded perspective view illustrating the preferred embodiment of a case for mounting slidably a data storage medium in a computer housing;

FIG. 4 is an assembled sectional view of the preferred embodiment with the data storage medium received therein; and

FIG. 5 is an exploded perspective view of the preferred embodiment.

### DETAILED DESCRIPTION OF THE PREFERRED EMBODIMENT

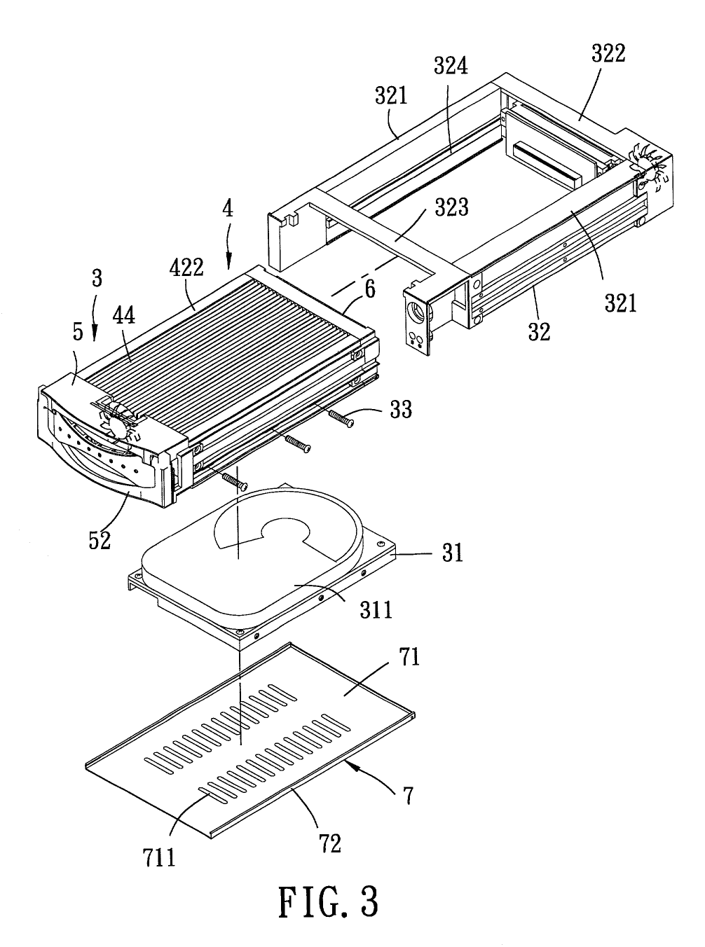

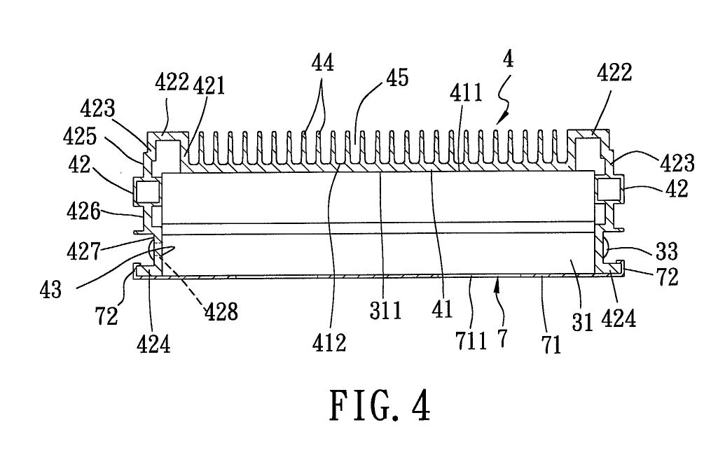

Referring to FIGS. 3 and 4, the preferred embodiment of a case 3 according to the present invention is shown to comprise a metal upper casing part 4, a front end cap 5, a rear end frame 6 and a cover plate 7.

The case 3 receives a data storage medium 31 therein. Fasteners 33 are used to secure the data storage medium 31 in the case 3. The case 3 is mounted slidably on a mounting frame 32 of the computer housing. The data storage medium 31 has a metal casing 311. The mounting frame 32 includes a parallel pair of confining walls 321, and a rear wall 322 interconnecting rear ends of the confining walls 321. A connecting strip 323 interconnects the confining walls 321 adjacent to front ends of the same. Each of the confining walls 321 has a slide rail 324 that extends in a direction from its front end toward its rear end.

The upper casing part 4, which is an integrally molded unit made from aluminum or aluminum alloy, has a horizontal top wall 41 and a pair of lateral walls 42 extending downwardly and respectively from opposite lateral edges of the top wall 41. The upper casing part 4 confines a receiving space 43. The top wall 41 has a lower surface 411 and an opposite upper surface 412. The upper surface 412 of the top wall 41 is formed with a plurality of upright heat dissipating fins 44 extending in a direction from the front edge of the top wall 41 toward the rear edge of the same. Adjacent fins 44 form a groove 45 therebetween. It should be noted that, as long as they are capable of serving the purpose of heat dissipation, the shape and layout of the fins 44 should not be limited to those of the present embodiment.

Each of the lateral walls 42 has a vertical flange 421 extending upwardly from one of the lateral edges of the top wall 41, a horizontal flange 422 extending from the vertical flange 421 in the direction away from the other of the lateral walls 42, a vertical portion 423 extending downwardly from the horizontal flange 422, and a lateral flange 424 extending in a direction away from the other of the lateral walls 42 at the bottom edge of the vertical portion 423. The outer surface of the vertical portion 423 of each of the lateral walls 42 is formed with two protruding portions to configure the same with an upper receiving groove 425, a middle receiving groove 426 and a bottom receiving groove 427. The bottom receiving groove 427 has a groove bottom formed with a plurality of oval holes 428 for passage of the fasteners 33. In this embodiment, the fins 44 have top ends flush with the horizontal flanges 422.

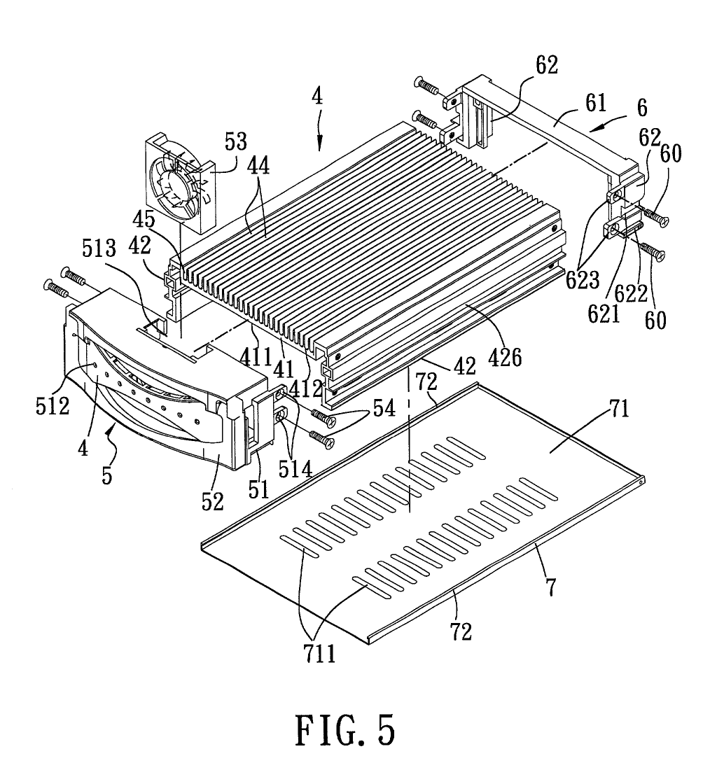

With further reference to FIG. 5, the front end cap 5 is mounted on a front end of the upper casing part 4 so as to cover a front opening of the receiving space 43. The front end cap 5 includes a molded plastic cap body 51, a handle 52 mounted on an outer side of the cap body 51, a fan 53, and a plurality of fasteners 54. The cap body 51 has a face plate portion 511 formed with a plurality of vent holes 512 for fluid communication with the receiving space 43. The cap body 51 has an inner side formed with a fan-mounting cavity 513. The fan 53 is mounted in the cavity 513. Each of the opposite lateral sides of the cap body 51 is formed with a pair of rearwardly projecting tabs 514 that extend into the front ends of the upper and middle receiving grooves 425, 426 of one of the lateral walls 42. The fasteners 54 extend through the tabs 514 and engage threadedly the groove bottoms of the upper and middle receiving grooves 425, 426 of the lateral walls 42.

The rear end frame 6 is mounted on the upper casing part 4 adjacent to a rear open end of the receiving space 43, and includes a horizontal strip 61 and a pair of side strips 62 that extend downwardly from opposite lateral ends of the horizontal strip 61. Each side strip 62 is formed with an insert groove 621 that is registered with the middle receiving groove 426 of one of the lateral walls 42, a lateral flange 622 aligned with the lateral flange 424 on one of the lateral walls 42, and a pair of forwardly projecting tabs 623 that extend into the rear ends of the upper and bottom receiving grooves 425, 427 of one of the lateral walls 42. Fasteners 60 extend through the tabs 623 and engage threadedly the groove bottoms of the upper and bottom receiving grooves 425, 427 of the lateral walls 42.

The cover plate 7, which is mounted on the upper casing part 4 and the rear end frame 6, includes a plate body 71 and a pair of hooks 72 that extend upwardly and then inwardly from the opposite lateral portions of the plate body 71. The plate body 71 is formed with a plurality of vent holes 711. The hooks 72 engage slidably and removably the flanges 424 on the lateral walls 42 and the flanges 622 on the side strips 62.

During assembly, the fasteners 54 and 60 are used to join the front end cap 5 and the rear end frame 6 to the upper casing part 4. The data storage medium 31 is then placed in the receiving space 43, and the casing 311 of the data storage medium 31 is fastened to the upper casing part 4 by the fasteners 33 such that the casing 311 is in contact with the lower surface 411 of the top wall 41 of the upper casing part 4. Finally, the cover plate 7 engages slidingly the rear end frame 6 and the upper casing part 4. At this time, the assembly of the case 3 and the data storage medium 31 can be mounted slidably on the confining walls 321 of the mounting frame 32 by virtue of sliding engagement between the slide rails 324 and the middle receiving grooves 426 in the lateral walls 42 of the upper casing part 4.

Because the lower surface 411 of the top wall 41 is in close contact with the casing 311 of the data storage medium 31, the heat generated during operation of the data storage medium 31 can be transmitted directly and rapidly to the top wall 41 for dissipation by the fins 44.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A case adapted for mounting slidably a data storage medium in a computer housing, said case comprising:
a metal upper casing part having a top wall with opposite front and rear edges and opposite lateral edges that interconnect said front and rear edges, said top wall having opposite upper and lower surfaces, said upper surface of said top wall being formed with a plurality of heat dissipating fins, said upper casing part further having a pair of lateral walls with top edges connected to said lateral edges of said top wall, said lateral walls extending downwardly and respectively from said lateral edges of said top wall, said lateral walls further having bottom edges opposite to said upper edges; and
a cover plate having opposite lateral portions connected removably to said bottom edges of said lateral walls, said cover plate cooperating with said upper casing part to confine a receiving space adapted for receiving the data storage medium therein such that the data storage medium is in contact with said lower surface of said top wall.

2. The case according to claim 1, wherein said upper casing part is an integrally formed unit.

3. The case according to claim 1, wherein said lateral walls are adapted to slidably engage the computer housing.

4. The case according to claim 3, wherein each of said lateral walls has an outer surface formed with a groove that extends in a direction from said front edge toward said rear edge of said top wall so as to be adapted to slidably engage the computer housing.

5. The case according to claim 3, further comprising a front end cap mounted on said upper casing part to cover a front open end of said receiving space.

6. The case according to claim 5, wherein said front end cap is formed with a plurality of vent holes in fluid communication with said receiving space.

7. The case according to claim 6, wherein said front end cap has an inner side formed with a fan-mounting cavity, said case further comprising a fan mounted in said fan-mounting cavity.

8. The case according to claim 5, wherein said front end cap has an outer side formed with a handle.

9. The case according to claim 5, wherein:
said front end cap has opposite lateral sides, each of which is formed with a rearwardly projecting tab;
each of said lateral walls having an outer surface formed with a receiving groove for receiving said tab on one of said lateral sides of said front end cap, said receiving groove having a groove bottom;
said case further comprising a pair of fasteners, each of which extends through one of said tabs and engages threadedly said groove bottom of said receiving groove in one of said lateral walls.

10. The case according to claim 5, further comprising a rear end frame mounted on said upper casing part adjacent to a rear open end of said receiving space.

11. The case according to claim 10, wherein:
said rear end frame has opposite lateral sides, each of which is formed with a forwardly projecting tab;
each of said lateral walls having an outer surface formed with a receiving groove for receiving said tab on one of said lateral sides of said rear end frame, said receiving groove having a groove bottom;
said case further comprising a pair of fasteners, each of which extends through one of said tabs and engages threadedly said groove bottom of said receiving groove in one of said lateral walls.

12. The case according to claim 1, wherein:
said bottom edge of each of said lateral walls is formed with a lateral flange that extends in a direction away from the other of said lateral walls, and that further extends in a direction from said front edge toward said rear edge of said top wall;
each of said lateral portions of said cover plate being formed with a hook for slidably engaging said lateral flange on said bottom edge of the respective one of said lateral walls.

13. The case according to claim 1, wherein said heat dissipating fins extend in a direction from said front edge toward said rear edge of said top wall and are parallel to each other.

14. The case according to claim 1, wherein said top edge of each of said lateral walls is formed with a horizontal flange that extends toward the other of said lateral walls, and a vertical flange that interconnects said horizontal flange and one of said lateral edges of said top wall.

15. The case according to claim 14, wherein said heat dissipating fins have top ends flush with said horizontal flanges on said lateral walls.
